(19) United States
(12) Patent Application Publication
(10) Pub. No.: US 2009/0259564 A1
(43) Pub. Date: Oct. 15, 2009

(54) METHOD, SYSTEM, AND STORAGE DEVICE FOR AN ONLINE CONTENT MARKETPLACE AND EXCHANGE

(76) Inventor: Thomas Pike Barkerding, Covington, LA (US)

Correspondence Address: HULSEY IP INTELLECTUAL PROPERTY LAWYERS, P.C., 919 Congress Avenue, Suite 919, AUSTIN, TX, 78701, US

(21) Appl. No.: 12/412,428

(22) Filed: Mar. 27, 2009

Related U.S. Application Data
(60) Provisional application No. 61/039,870, filed on Mar. 27, 2008.

(51) Int. Cl. G06Q 30/00; G06Q 50/00; G06Q 20/00

(52) U.S. Cl. 705/26

(57) ABSTRACT

A method, system, and storage device for an online content marketplace and exchange which enables independent content creators to protect their content while permitting interested buyers to financially compete over the rights to the content, thus achieving true market value for the creator based upon the market's willingness to pay for the content. The method is capable of receiving content (e.g. video, audio, image, etc.), transcoding the content, applying encryption and watermarks, configuring an auction, conducting the auction, finalizing the auction, and releasing the original content to the winning bidder.

### RELATED APPLICATION

This application claims the benefit of priority to U.S. Provisional Patent Application No. 61/039,870 entitled “A METHOD, SYSTEM, AND STORAGE DEVICE FOR AN ONLINE VIDEO MARKETPLACE AND EXCHANGE” filed Mar. 27, 2008.

### FIELD OF THE INVENTION

The disclosed subject matter relates primarily to systems and methods for online content brokerage.

### BACKGROUND OF THE INVENTION

With the global proliferation of image capturing technology over recent years, cameras are seemingly everywhere. The latest cell phone models being introduced in the U.S. are equipped with up to 8-megapixel cameras, resulting in the most omnipresent, highest quality consumer camera devices ever made. Never before have the masses had such immediate access to high-resolution cameras that never leave their pockets. The effect? Average citizens are now capable of capturing valuable images and other content more than ever before, a phenomenon that will only increase as technology continues to advance the availability and affordability of consumer cameras.

Unfortunately much of today's valuable, independently created content is simply given away either directly to soliciting publications (i.e. iReport.com® (a registered trademark of Cable News Network, Inc.), UReport.com, local news sites, TMZ® (a registered trademark of Warner Bros. Entertainment, Inc.), etc.), submitted to high-commission media agencies, or uploaded to online video/photo sharing sites like YouTube® (a registered trademark of Google, Inc.), where its value quickly depreciates with time and exposure. The content is often exploited by the publications with little if any compensation awarded to the creator. This occurs because no alternative exists where independent creators can protect and effectively monetize their content. Why not? Because big media currently acquires user generated content (“UGC”) at a significant discount, and creating a free market is counter-intuitive to this benefit. A strong need exists for an independent marketplace, a virtual platform that will link independent creators and their content directly to interested buyers.

Additionally, online content sharing is one of the fastest growing industries on the Internet. Everyday, hundreds of millions of people are depending more and more on a variety of online sources to provide them with the latest in entertainment, news, communication, and information in general.

Despite the strong viewer following, the online content industry remains in a particularly undefined and developmental stage. A number of problems currently trouble the industry. The main ones include copyright piracy, monetization, and saturation.

The first problem has quickly become the subject of much heated debate between content creators/owners and video sharing sites. The intensification of these legal battles (i.e. Viacom et al vs. YouTube/Google) could spell certain doom for many video sharing sites, whose success largely depends on the illegal use of copyrighted material. Pressure from ongoing litigation and the development of formidable digital rights management (“DRM”) technology is slowly but surely limiting the ability for content sharing sites to turn a blind eye to piracy. Once these restrictions fully evolve many content-sharing sites will lose the ability to legally broadcast copyrighted material to which they do not have rights. This will cause the sites to forfeit large portions of their viewer market share, forcing them to obtain legitimate content rights through sites regulated by content owners.

As briefly mentioned above, monetization also serves as a problematic issue in the industry. Because content sharing sites profit from soliciting free, user-made content, traditional content sharing sites are hesitant and unwilling to pioneer innovative and effective efforts to monetize the content exchange market. Why should they if they are getting content for free? The reason the content market is not monetized is thus blamed on the content creators and owners for giving their content away for free. Therefore, a way to begin monetizing the market is by discouraging content creators/owners from voluntarily donating their work.

With the ongoing proliferation of broadband Internet, the online content industry has experienced a steep rise in consumer interest. In response, hundreds of video sharing and other content websites are being created in a race to harness as much market share as possible. The recent success of the market leader YouTube™ has spawned much of this content gold rush, which is beginning to resemble the reckless attitude experienced in the 1999 dot-com bubble. This eerie resemblance lies in the constant inability for most of these content-sharing websites to provide a unique business model that will significantly impact the progression of the industry. Thus, the online content industry is quickly becoming saturated with run-of-the-mill content sharing websites that offer little variation from the standard YouTube™ model.

In the online media industry, there is a very strong demand for a content intermediary that will offer creators a chance to sell their material for true market value. As an online brokerage that will allow the owners of content to auction their material online to interested buyers, the subject matter disclosed herein provides the solution to satisfy the growing demand.

Whether it is an unflattering photo of a celebrity, camera phone footage of an airline landing in a river, or even a humorous video clip of a turtle chasing a cat, millions of creators are uploading their original media content to the World Wide Web on a daily basis. In a recent, more specific phenomenon, video creators have begun to upload their videos to familiar sites such as iReport®, YouTube®, Yahoo!® Videos (a registered trademark of Yahoo!, Inc.), Break.com, DailyMotion.com, Metacafe.com, and many other online media-sharing sites capable of broadcasting content to the rest of the world. In turn, these websites use this UGC to generate enormous amounts of advertising revenue based on the amount of interest generated by the posted item. This, as many already know, is how traditional broadcasters and content sharing websites earn revenue.

While these popular media network broadcasters collect ad revenue and exploit user talent, the creator is left with the mere satisfaction that his work is being broadcast on the Internet. Although a video and/or still image owner may consider his or her content to be successful and popular if it receives many hits on YouTube™ or it is published on CNN's™ cable network, he is ultimately cut out of the ad revenue generated by the number of hits that his material receives, surrendering most—if not all—financial credit to the publishing entity.

The disclosed subject matter seeks to fill these needs. The invention adds transparency and free market dynamics to the current UGC distribution process, enabling creators to protect and promote their content directly to competing media outlets in an online auction setting, forcing buyers to financially compete for rights, and yielding true market value to creators.

The disclosed subject matter serves as the only online gathering point and auction-style clearinghouse for freelance photojournalists, paparazzi, citizen journalists and other independent creators of valuable content.

### BRIEF SUMMARY OF THE INVENTION

There is a need for a method, system, and/or storage device that allows for efficient brokerage and exchange of content and offers a distinctive, revolutionary model to capitalize on the monotonous inefficiencies of the current distribution methods of independent content producers.

The disclosed subject matter generally describes a web-based brokerage that will provide an online marketplace for owners of content, more specifically video, audio, still images, and the like, to auction the rights to their content to media publications and any other interested buyers. Throughout this disclosure, video is intended to also include still images and audio.

The disclosed subject matter challenges the current lopsided market structure with a solution that will balance the distribution of financial compensation between interested buyers and independent content creators.

A technical advantage of the disclosed subject matter is providing independent content owners with the ability to exercise more bargaining power for their intellectual property by forcing publications and other interested buyers to financially compete over their product, yielding true market value to the creator. The chance to achieve greater compensation for their work will incentivize content owners to use the invention in place of less lucrative methods.

A technical advantage of one embodiment of the disclosed subject matter is providing multiple levels or tiers of buyers to assist sellers of content in targeting the most relevant and therefore the most interested buyers.

Yet another technical advantage of the disclosed subject matter is providing multiple methods for users to submit content, sell content, search for content, and purchase content.

A technical advantage of an alternative embodiment is providing users the ability to control the level of exposure by holding private sales of content.

An additional technical advantage of the disclosed subject matter is protecting user's content from unauthorized use.

Yet another technical advantage of the disclosed subject matter is providing content sellers the means to benefit from the high market demand for their content.

Another technical advantage of the disclosed subject matter is providing an additional content source to the media industry, to which all publications and other interested buyers are given free, democratic, and convenient access. Further, the invention does not compete or interfere with current methods of content acquisition, but will only serve as an optional service above and beyond existing content gathering practices.

Another technical advantage of the disclosed subject matter is objective pricing for content achieved through an auction system that gives buyers the ability to assign their own value assessment to content and to bid according to that perceived value. This provides flexibility and control for buyers, allowing them to contain bids within their budget and/or scope of interest while obtaining true market value for the content seller.

Another technical advantage of the disclosed subject matter is eliminating the need for middlemen and media agencies, which often apply hefty premiums to content sales that disproportionately and unnecessarily lower seller commissions and drive up content prices for buyers. By directly linking sellers with interested buyers through an efficient online platform, the need for middlemen is removed at the benefit of both sides of the market.

Another technical advantage of the disclosed subject matter is maximizing the immediacy of content distribution. As an on-line application, the invention gives sellers an immediate ability to list content, in turn providing buyers with immediate access to that content, and thus minimizing lag time between content creation and publication, and preserving the immediacy demanded by certain buyers (e.g. news industry).

Another technical advantage of the disclosed subject matter is the ability for buyers to purchase the exclusive rights to content, legally securing outright ownership while protecting the integrity of the content from fraudulent reproductions and infringement by competitors or other unscrupulous parties.

Another technical advantage of the disclosed subject matter is user anonymity, which protects the identity of users, preventing personal information from influencing the integrity of the market (e.g. a celebrity purchases an unflattering video to keep it out of the media—because of the anonymity, no one knows the celebrity was the one to purchase the video).

These and other aspects of the disclosed subject matter, as well as additional novel features, will be apparent from the description provided herein. The intent of this summary is not to be a comprehensive description of the claimed subject matter, but rather to provide a short overview of some of the subject matter's functionality. Other systems, methods, features and advantages here provided will become apparent to one with skill in the art upon examination of the following FIGUREs and detailed description. It is intended that all such additional systems, methods, features and advantages that are included within this description, be within the scope of the included claims.

### BRIEF DESCRIPTIONS OF THE DRAWINGS

The features, nature, and advantages of the disclosed subject matter will become more apparent from the detailed description set forth below when taken in conjunction with the accompanying drawings, wherein:

FIG. 1 illustrates a computer system and related peripherals that may operate with the job posting and matching service of the present embodiment.

FIG. 2 depicts a flow chart of the upload video submission process of the video marketplace and exchange of the present embodiment.

FIG. 3 depicts a flow chart of the auction setup process of the video marketplace and exchange of the present embodiment.

FIG. 4 depicts a flow chart of the sale closing process of the video marketplace and exchange of the present embodiment.

FIGS. 5a-b and 6a-c depict some options that could be available to users via the UI for the sell and buy areas respectively.

FIG. 7 depicts a flow chart of the public release process of the video marketplace and exchange of the present embodiment.

FIG. 8 depicts a flow chart of the private release process of the video marketplace and exchange of the present embodiment.

FIG. 9 depicts a graphical representation of the system architecture of the video marketplace and exchange of the present embodiment.

### DETAILED DESCRIPTION OF ILLUSTRATIVE EMBODIMENTS

Although described with reference to specific embodiments, one skilled in the art could apply the principles discussed herein to other areas and/or embodiments. Further, one skilled in the art could apply the principles discussed herein to communication mediums beyond the Internet, including, but not limited to: cellular telephones, personal digital assistants, mobile digital assistants, web enabled cameras, email, desktop widget, mobile web, email, really simple syndication (“RSS”), etc. Although described with reference to video and images, one skilled in the art could employ this disclosure to include other media and forms of content.

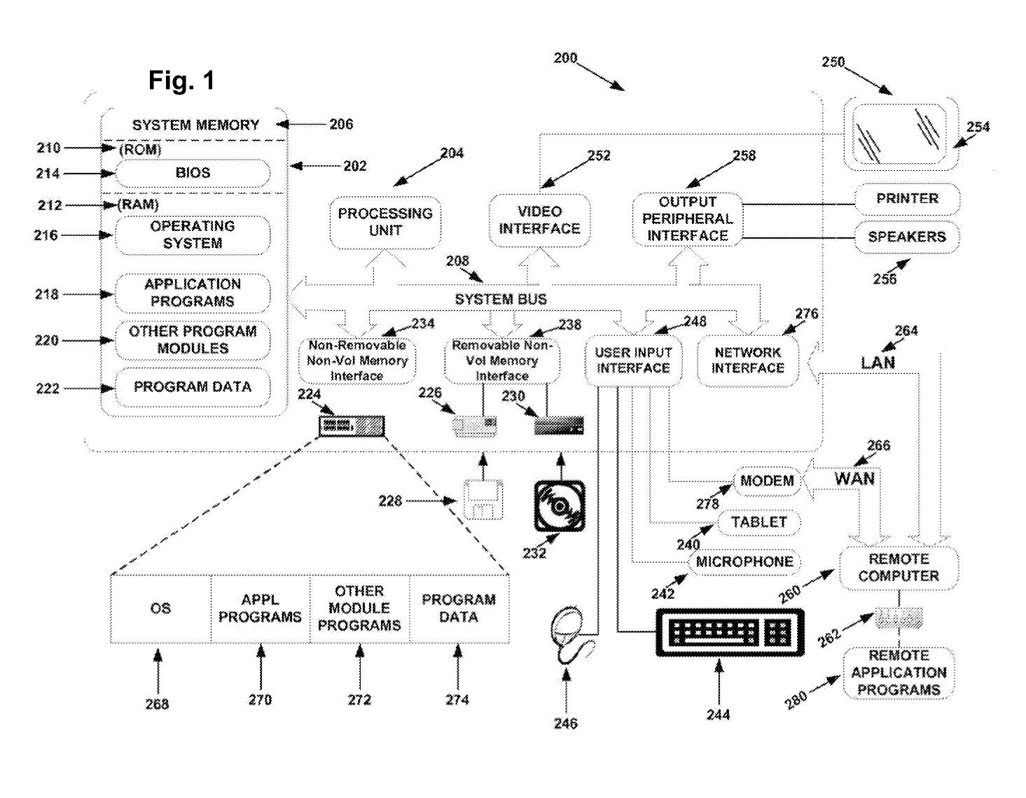

With reference to FIG. 1, an exemplary system within a computing environment for implementing the invention includes a general purpose computing device in the form of a computing system 200, commercially available from Intel, IBM, AMD, Motorola, Cyrix and others. Components of the computing system 202 may include, but are not limited to, a processing unit 204, a system memory 206, and a system bus 236 that couples various system components including the system memory to the processing unit 204. The system bus 236 may be any of several types of bus structures including a memory bus or memory controller, a peripheral bus, and a local bus using any of a variety of bus architectures.

Computing system 200 typically includes a variety of computer readable media. Computer readable media can be any available media that can be accessed by the computing system 200 and includes both volatile and nonvolatile media, and removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data.

Computer memory includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the computing system 200.

The system memory 206 includes computer storage media in the form of volatile and/or nonvolatile memory such as read only memory (ROM) 210 and random access memory (RAM) 212. A basic input/output system 214 (BIOS), containing the basic routines that help to transfer information between elements within computing system 200, such as during start-up, is typically stored in ROM 210. RAM 212 typically contains data and/or program modules that are immediately accessible to and/or presently being operated on by processing unit 204. By way of example, and not limitation, an operating system 216, application programs 220, other program modules 220 and program data 222 are shown.

Computing system 200 may also include other removable/non-removable, volatile/nonvolatile computer storage media. By way of example only, a hard disk drive 224 that reads from or writes to non-removable, nonvolatile magnetic media, a magnetic disk drive 226 that reads from or writes to a removable, nonvolatile magnetic disk 228, and an optical disk drive 230 that reads from or writes to a removable, nonvolatile optical disk 232 such as a CD ROM or other optical media could be employed to store the invention of the present embodiment. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 224 is typically connected to the system bus 236 through a non-removable memory interface such as interface 234, and magnetic disk drive 226 and optical disk drive 230 are typically connected to the system bus 236 by a removable memory interface, such as interface 238.

The drives and their associated computer storage media, discussed above, provide storage of computer readable instructions, data structures, program modules and other data for the computing system 200. For example, hard disk drive 224 is illustrated as storing operating system 268, application programs 270, other program modules 272 and program data 274. Note that these components can either be the same as or different from operating system 216, application programs 220, other program modules 220, and program data 222. Operating system 268, application programs 270, other program modules 272, and program data 274 are given different numbers hereto illustrates that, at a minimum, they are different copies.

A user may enter commands and information into the computing system 200 through input devices such as a tablet, or electronic digitizer, 240, a microphone 242, a keyboard 244, and pointing device 246, commonly referred to as a mouse, trackball, or touch pad. These and other input devices are often connected to the processing unit 204 through a user input interface 248 that is coupled to the system bus 208, but may be connected by other interface and bus structures, such as a parallel port, game port or a universal serial bus (USB).

A monitor 250 or other type of display device is also connected to the system bus 208 via an interface, such as a video interface 252. The monitor 250 may also be integrated with a touch-screen panel or the like. Note that the monitor and/or touch screen panel can be physically coupled to a housing in which the computing system 200 is incorporated, such as in a tablet-type personal computer. In addition, computers such as the computing system 200 may also include other peripheral output devices such as speakers 254 and printer 256, which may be connected through an output peripheral interface 258 or the like.

Computing system 200 may operate in a networked environment using logical connections to one or more remote computers, such as a remote computing system 260. The remote computing system 260 may be a personal computer, a server, a router, a network PC, a peer device or other common network node, and typically includes many or all of the elements described above relative to the computing system 200, although only a memory storage device 262 has been illustrated. The logical connections depicted include a local area network (LAN) 264 connecting through network interface 276 and a wide area network (WAN) 266 connecting via modem 278, but may also include other networks. Such networking environments are commonplace in offices, enterprise-wide computer networks, intranets and the Internet.

For example, in the present embodiment, the computer system 200 may comprise the source machine from which data is being generated/transmitted, and the remote computing system 260 may comprise the destination machine. Note however that source and destination machines need not be connected by a network or any other means, but instead, data may be transferred via any media capable of being written by the source platform and read by the destination platform or platforms.

The central processor operating pursuant to operating system software such as IBM OS/2®, Linux®, UNIX®, Microsoft Windows®, Apple Mac OSX® and other commercially available operating systems provides functionality for the services provided by the present invention. The operating system or systems may reside at a central location or distributed locations (i.e., mirrored or standalone).

Software programs or modules instruct the operating systems to perform tasks such as, but not limited to, facilitating client requests, system maintenance, security, data storage, data backup, data mining, document/report generation and algorithms. The provided functionality may be embodied directly in hardware, in a software module executed by a processor or in any combination of the two.

Furthermore, software operations may be executed, in part or wholly, by one or more servers or a client's system, via hardware, software module or any combination of the two. A software module (program or executable) may reside in RAM memory, flash memory, ROM memory, EPROM memory, EEPROM memory, registers, hard disk, a removable disk, a CD-ROM, DVD, optical disk or any other form of storage medium known in the art. An exemplary storage medium is coupled to the processor such that the processor can read information from, and write information to, the storage medium. In the alternative, the storage medium may be integral to the processor. The processor and the storage medium may also reside in an application specific integrated circuit (ASIC). The bus may be an optical or conventional bus operating pursuant to various protocols that are well known in the art.

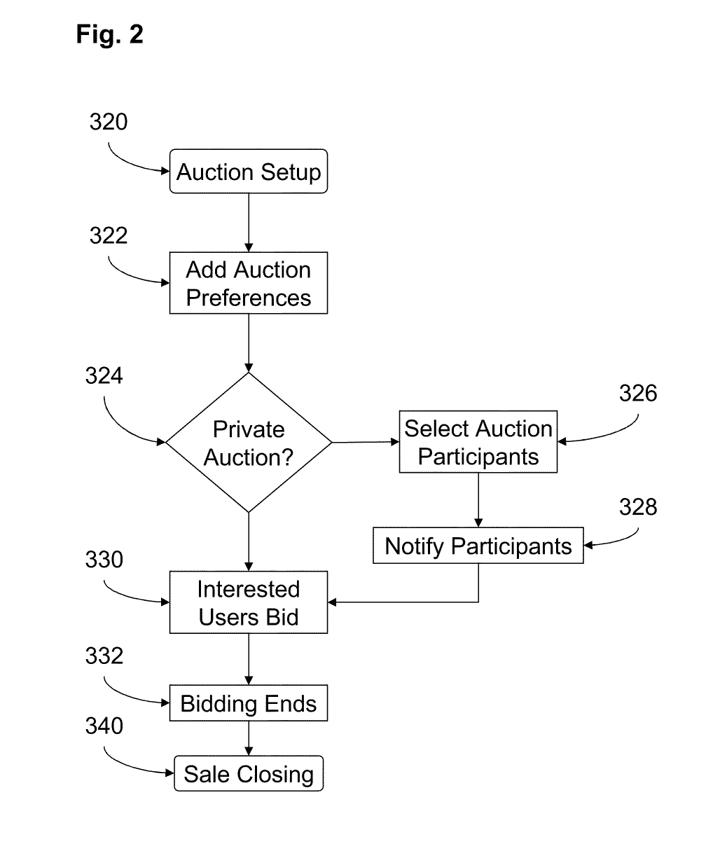

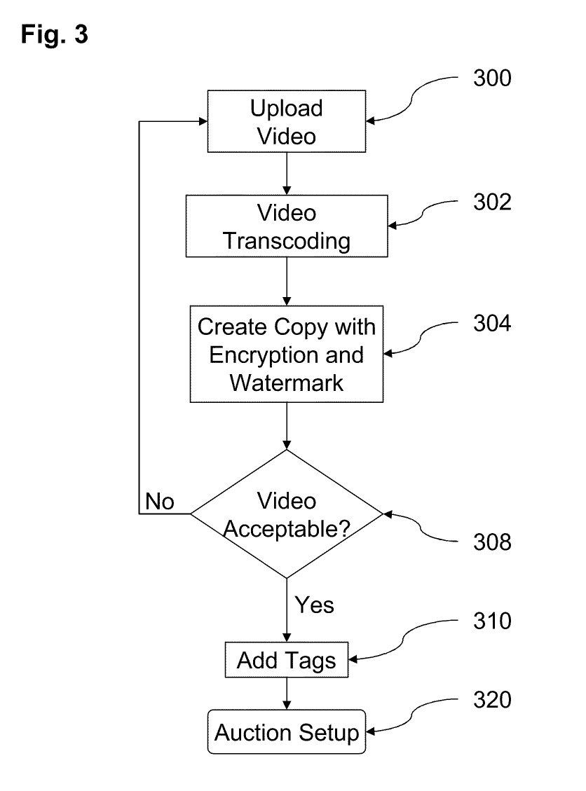

FIG. 2 depicts a flow chart of the auction setup 320 process of the content marketplace and exchange of the present embodiment. For the explanation regarding FIGS. 2 and 3, a video will be used to describe the process; however, other content can be implemented using the same process. The user first sets the auction preferences 322. The auction preferences 322 could include such items as: type of auction, auction length, minimum bid price, description, etc.

The user adds tags to describe the video 310. These tags could include keywords, potential users, categories, language, rating, views, status, location, or other information that describes and/or distinguishes the subject and content of the video. In one embodiment, the system automatically adds statistical information about the video, such as: length, original format, resolution, number of frames per second, interlacing, aspect ratio, color space, compression method, bit rate, etc. Finally, the user could then proceed to the file upload.

Additionally, the tags would be searchable by users to identify potential videos of interest. For example, if a potential bidder only wanted to view videos made/concerning a certain geographic area, the potential bidder could search for that particular area and the search could not only return a list of the available videos, but also a map showing the subject location of the available videos.

In the preferred embodiment the seller must sell the exclusive rights to the content; however, in another embodiment, alternative royalty structures could be employed. If this is the case, because a royalty stipulation may affect otherwise likely bids, the seller would have the ability to choose whether or not the royalty option is applied. Multiple after-sale royalty and/or license options could also be implemented. One condition could require that royalties be paid based on the number of times content is used/broadcast after the initial sale. This royalty amount could reflect either a percentage agreed upon by the buyer and seller or simply a share in the ad revenue generated by its use. For example, YouTube™ has recently implemented a new ad system that charges advertisers $20 CPM (cost per one thousand views). With 100 million video views PER DAY, this translates into serious revenue for YouTube™. By instigating a royalty structure that includes 25% of ad revenue as a royalty payment, a video that generated 500,000 views, the video owner would in turn receive $2500 (500×$20 CPM×0.25).

Another way to exercise the after-sale royalty option would be for the seller to retain a percentage of every additional sale or licensing of the content after the initial auction. This means that, should the auction winner resell the content rights, the original owner would receive a set percentage of those sales.

Additionally, alternative licensing arrangements could be permitted, such as: non-exclusive rights to multiple bidders; exclusive rights for a set time period then the rights convert to either non-exclusive or expire; etc.

If alternative royalty and/or licensing structures are employed, all bidders would need to be made fully aware of the conditions existing in an auction prior to their ability to bid and would be required to agree to the seller's chosen conditions prior to bidding. This would ideally be accomplished during auction setup.

Additionally, the auctioning user may select the item to be automatically relisted. In the event there were no bids on an item, the auction would automatically begin again with the same settings. In the preferred embodiment of this feature, an email or other notification would be sent to the auctioning user. Additionally, notifications could be sent to any other users who were “watching” the original (or a subsequent) auction. Finally, in an alternative embodiment of this feature, there could be an automatic relist with price lowering option. If there were no bids, the auction would be relisted automatically with all the same settings except the price would be lowered a fixed amount (e.g. a certain dollar amount; a percentage; etc.).

FIG. 3 depicts a flow chart of the upload content submission process of the content marketplace and exchange of the present embodiment. First, the user uploads their video to the system 300. The user could accomplish this through a web interface, email, desktop widget, cell phone, or other communication medium. Once the video is uploaded, the system automatically performs video transcoding 302. Video transcoding is the process of re-purposing video into one or more different formats (e.g. DivX, DV-AVI, DVD (MPEG2), Flash® Video (FLV) (a registered trademark of Adobe Systems Incorporated), HD DVD® (WMVHD) (a registered trademark of DVD Format/Logo Licensing Corporation), QuickTime® (MOV) (a registered trademark of Apple Computer, Inc.), RealMedia (RM), SVCD, VCD, Windows Media Video (WMV), MPEG-4 (mp4), BluRay, etc.). Next, the original video is stored securely without modification and a copy is created with encryption (a watermark interlaced into the content) and/or a watermark overlaid 304 (encryption/watermarking are referred to throughout interchangeably and either word is intended to include the other). In the preferred embodiment, the watermark will be centered on the video and covering at least ¼^{th} of the image (for the alternative embodiment of an audio recording, the watermark could be an integrated/overlaid audio track such as another recording, a continuous or intermittent beeping, etc.). The encryption is intended to stop unscrupulous users from downloading and/or copying the video, thus protecting it from being broadcasted illicitly by other publications. Further, the watermark is intended to make the video significantly less valuable and less enjoyable than the original, thereby preventing overexposure, and preserving its appeal to prospective buyers who wish to publish it without the watermark.

In another embodiment, the user would have the ability to control the exposure level of his or her content by making the auction as private or public as the user saw fit 324. If the user chose to hold a private auction, the user would select who would participate in the auction 326. The system could also automatically suggest potential auction participants based on their particular interests and the content's tags. The potential auction participant's interest could be determined directly by input from that user and/or indirectly by analyzing that user's buying and/or viewing habits. After the user had selected the auction participants, the system would notify the participants of the auction 328. This notification could be via email, instant message, text message, page, desktop widget, online alert, etc. Thereafter, private and public auctions proceed in the same manner. Any interested bidders place bids on the content 330 and the bidding continues until the auction's ending time is reached 332. Provided there was at least one bid, the winning bidder would then proceed to close the sale of the content 340.

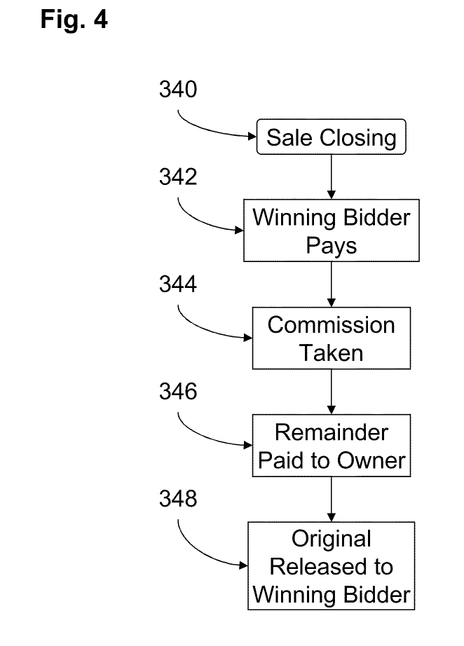

FIG. 4 depicts a flow chart of the sale closing 340 process of the content marketplace and exchange of the present embodiment. The winning bidder pays the winning bid amount 342. A commission is deducted from the payment amount 344 and the remainder is paid to the auctioning user 346. Finally, the original content is released to the winning bidder and the watermarked auction copy is then completely removed from both the site (and anywhere else it might be embedded) so that it is no longer accessible by the public. In an alternative embodiment, an auction could be immediately closed upon a user paying a seller's pre-determined price.

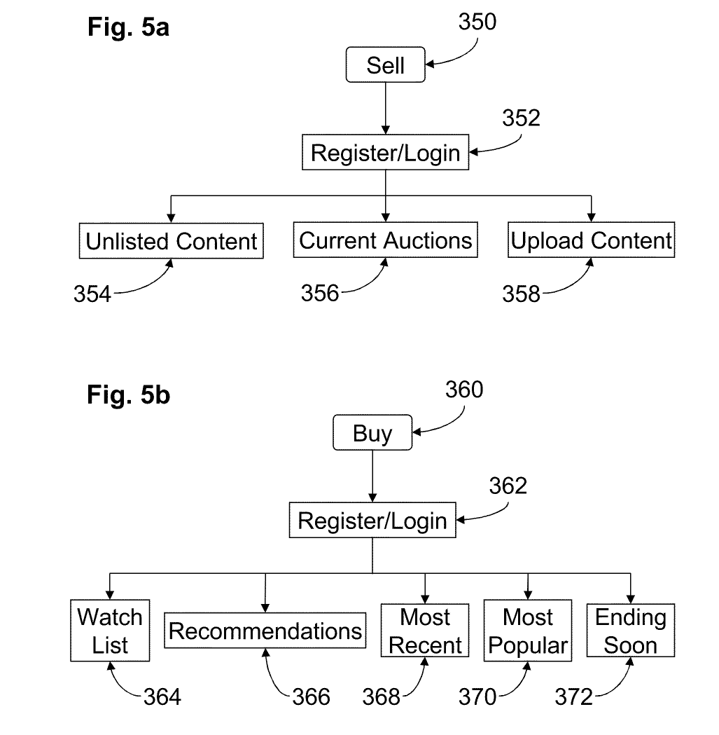

In the preferred embodiment the majority of the interaction between a user and the system will be done via a user interface (“UI”). In one embodiment, the UI is broken into two major areas: Sell 350 and Buy 360. FIGS. 5a and 5b depict some options that could be available to users via the UI for the sell 350 and buy 360 areas respectively. After choosing the sell 350 portion, the user would be prompted to either register or login 352. The registration process would include collecting pertinent information about the user which could include: name, address, phone, email, experience, interests, etc. In one embodiment, the user then has three sections: upload 358, unlisted content 354, and current auctions 356. The upload section is where the user may submit content to his account on the system. The unlisted content 354 section would list any content the user has already submitted but has not chosen to place in an auction. The current auctions 356 section shows the user's auctions that are currently underway or recently finished.

In the preferred embodiment, the UI is split into three major divisions: upload & sell (FIG. 6a), bid & buy (FIG. 6b), and my bideo (FIG. 6c). Referring to FIG. 6a, the upload & sell 351 division permits the user to provide information regarding the auction and the content the user wishes to upload such as auction settings 353, content information 355, and upload 358. Some of the auction settings 353 include: type of listing (auction or store), minimum bid amount, end auction amount (e.g. buy now price), auction start time, and auction duration. Some of the content information 355 includes: title, description, genre (e.g. news, entertainment, sports, creative, public figures, etc.), tags, date and time the content was captured or developed, and the location where the content was captured or concerns. The user is then permitted to upload 358 the content.

Referring to FIG. 6b, the bid & buy division allows a user to browse 359, search 361, sort 363, or bid 365 on content currently available for purchase. The user may narrow or sort 363 the content listing by type (e.g. video, image, etc.), genre, or other characteristic. Additionally, the user could enter keywords of content the were of particularly interest to the user. The system would automatically monitor new and existing auctions and notify the user of any auction matching the entered keywords.

Finally, referring to FIG. 6c, the my bideo 367 division gives the user quick access and a summary of the user's content, auctions where the user is selling 369 content, auctions where the user is bidding 371 on content, and auctions the user is watching 373.

In an alternative embodiment, when content is placed in a public auction, the user would have the option to allow third parties to embed the watermarked content into their website, blog, social network page, etc. and allow the third party to tag ads to the content. If the user opted to use this preference, then the system would provide the tools for external entities to embed the watermarked content anywhere on the Internet. The system would then track the embedded content's performance statistics, collect a portion of the ad revenue generated by the external promoter's broadcast, and still allow the option for any viewer to initiate an auction by bidding on the content, even when the content was hosted on a completely different website. Once an auction that is embedded in multiple locations is initiated and finalized within the home system or elsewhere, the content would be instantly removed from all internal and external locations and the original would be transferred to the winning bidder. With this option, a seller has the ability to earn a percentage of ad revenue generated and would also have other sources promoting the content while simultaneously preserving the ability to sell the rights to the content through an auction that could be initiated by a bid at any time from anywhere.

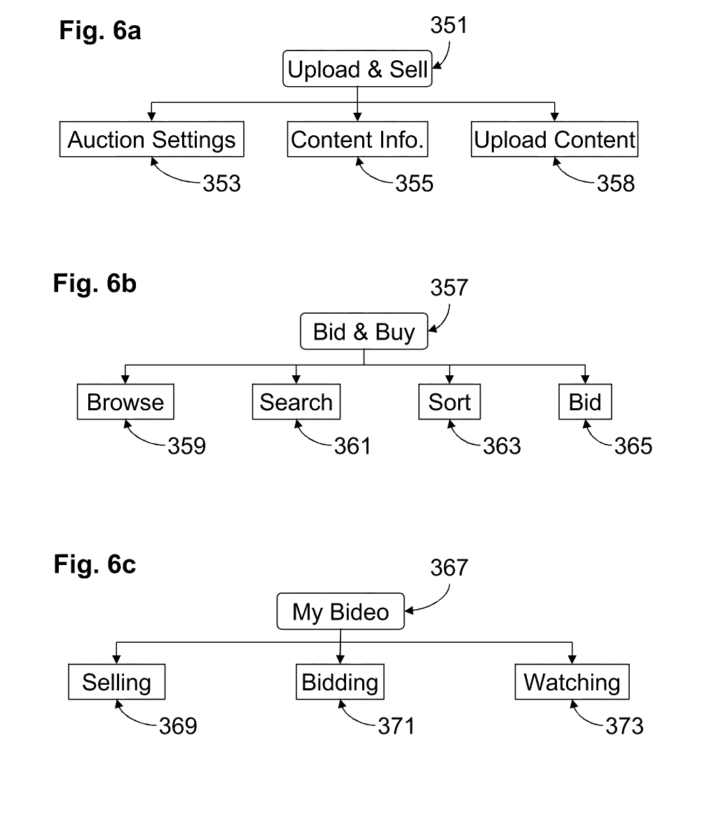

FIG. 7 depicts a flow chart of the public release 380 process of the content marketplace and exchange of the present embodiment. As discussed previously, in the preferred embodiment the auction is always a public auction; however, even in the private auction embodiment, if the private auction fails to result in a winning bidder, the content could be set to automatically be released in a public auction.

In yet another embodiment, the user may release the content for ad revenue 382 and/or as a public auction 386. As discussed previously, if the content was released for ad revenue 382, a portion of the ad revenue generated by that content would be paid to the user 384. In this embodiment, even if the user had chosen to release the content for ad revenue, an auction could be initiated at any time. If the user chose to have a public auction 386, then the auction would proceed as discussed previously in FIG. 2. If there were no bids by the end of the auction 390, the item could be automatically re-listed under the original auction settings 380; however, if there was a bid 388, then the auction would end with the sale closing 340.

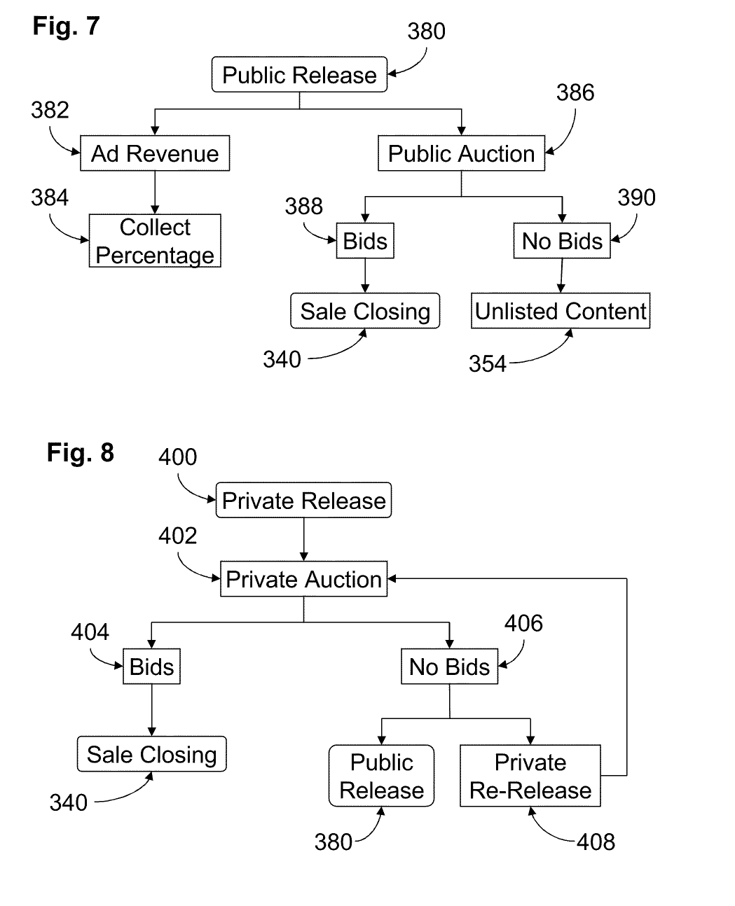

FIG. 8 depicts a flow chart of the private release 400 embodiment of the content marketplace and exchange. As discussed previously in FIG. 2, the user makes a video available for private auction 402. If there are no bids by the end of the limited time period within which a video can be privately listed 406, the user has the option of making a public release 380 or a private re-release 408. If the user does not choose either option, the video is automatically listed in the public release 380. However, if there was a bid 404, then the auction ends with the sale closing 340.

In an alternative embodiment, the potential bidder market would be broken into tiers. Each tier would be made up of potential buyers with similar characteristics. From the top tier to the third tier, each tier would be defined by an inverse relationship between public exposure and buyer seriousness. Each tier would be channeled to a specific buyer demographic, ranging from a more exclusive auction with more serious buyers (top tier), to a more exposed, open-source auction with less serious buyers (bottom tier).

For example, bidders could be broken into three tiers. Continuing this example, a user could decide to release their content to the top tier if they feel the content is very desirable or very high quality. The top tier bidders would be limited to only premium subscribing networks and content sharing companies. The content would only remain on the top tier auction for a limited time. If the content received no bids within the limited time period, the content would automatically be moved to the next lower tier (in this example the middle tier). Within the limited time period, the user could also voluntarily move the content to a lower tiered auction.

In this example, the middle tier is less exclusive than the top tier but not as open as the bottom tier. This middle tier is intended to be a balance between serious bidders and the general public. Buyers in this tier would pay a subscription fee substantially lower than that paid in the top tier. Again, if after a limited time period the content received no bids, the content would be automatically moved to the next lowest tier.

Still continuing this example, the bottom tier is available to any user and would serve primarily as a content sharing tier. The main difference between this tier and traditional content sharing websites is that any viewer could trigger an auction for any content by placing a bid. When a user triggered an auction, by bidding over the minimum bid price set by the seller, the auction would continue for a set period of time and conclude in the same manner as previously discussed.

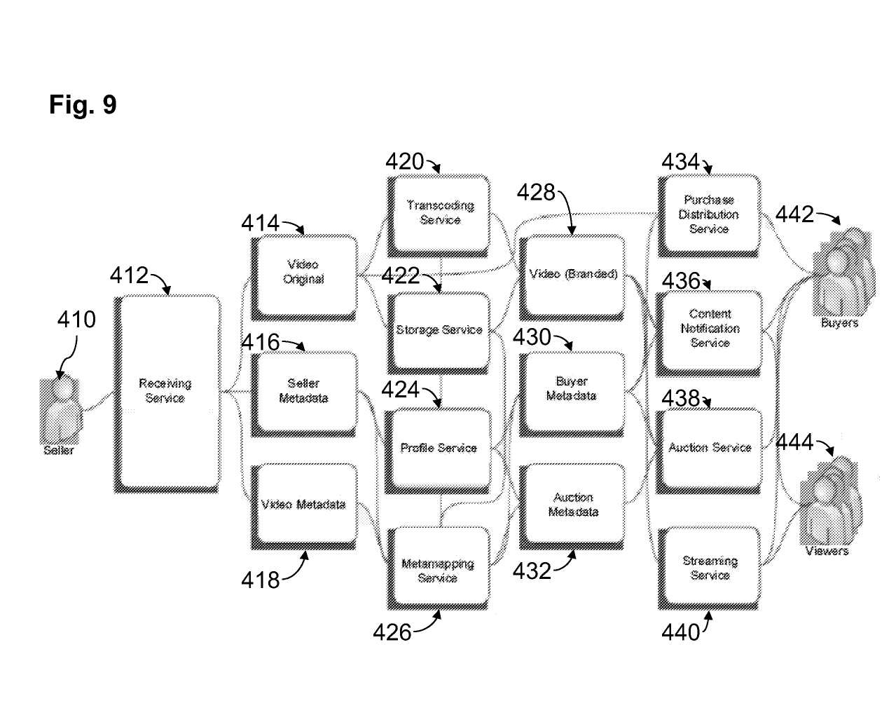

FIG. 9 depicts a graphical representation of the system architecture of the content marketplace and exchange of the present embodiment. Each major portion of the system architecture will be discussed individually below.

Receiving Services 412. Services in this set are the mechanisms designed to allow the uploading of new content: The sell set of pages in the website; The set of mobile web upload pages; The service that monitors inbound e-mails tied with users' accounts; The set of desktop widgets which allow uploading of new content; and other uploading devices and mechanisms. The receiving service 412 includes collection of the original content 414, seller metadata 416 (such as: profile account data, contact information, user preferences, historical site activity, performance data, other analytical data, etc.), and content metadata 418 (such as: descriptive data—format, length, size, date uploaded; video profile data, tag data, relevancy data, transcoding data, storage data, streaming data, etc.).

Transcoding Service 420. A wrapping service around the set of transcoding codecs used to convert content from the various formats accepted by the system receiving services 412 into the common format used throughout the system, and to overlay the watermark. The underlying transcoding mechanisms will be abstracted so that the upper level systems are not aware of the actual means used to transcode content from one format to another. Content handed to the transcoding service will be handed back in the common site format, with the watermark overlayed on top of the original content.

Storage Service 422. A wrapping service around the physical storage devices used to store content, content metadata, user account information, financial data, etc. The physical storage mechanisms will be abstracted so that the upper level systems and services are not aware of where or how the data is actually stored. Data handed to the storage service will be stored by the service and the service will give back a pointer or address that can later be used to retrieve the data back from physical storage.

Profile Service 424. A service which encapsulates storage and retrieval of account and profile information for all registered users and contacts known to the system. Sellers use the profile service to store their preferences about their accounts, and about how the system handles their content. Buyers use the profile service to store their preferences about what types of content interests them, and to store their preferences for participating in content auctions.

MetaMapping Service 426. A wrapping service around the store of metadata which ties together and relates content, sellers, and buyers. The metamapping service will support querying for information related to any artifact about which it maintains information.

Content (Branded) 428. Denotes a successfully transcoded piece of content complete with a watermark (brand).

Buyer Metadata 430. Responsible for collecting metadata similar to that collected for the seller metadata 416 and content metadata 418 but corresponding to the buyer.

Video Metadata 432. Responsible for collecting metadata similar to that collected for the seller metadata 416, content metadata 418, and Buyer Metadata 430 but corresponding to the auction.

Purchase Distribution Service 434. Responsible for delivering purchased content to the buyer of that content. In an alternative embodiment, this service could interact with the transcoding service to allow a buyer to specify an alternate preferred format in which to receive the purchased content, if the original content is not in a format that the buyer can, or wants, to use.

Content Notification Service 436. A wrapping service around the processes which use the data from the metamapping service 426 to determine which potential buyers to alert when new content is uploaded which those buyers might purchase. The content notification service will accept a pointer to new content, query the metamapping service 426 for information about that content, use that information to narrow down the list of potential buyers, determine the means of contacting those potential buyers, and then queue alerts to those buyers into the actual process that will perform the sending of the alert (e-mail, web service post, page, text message, RSS posting, etc).

Auction Service 438. A wrapping service around the processes involved in conducting an auction, including beginning auctions, managing bids, communicating auction status, concluding auctions, notifying winners, and accepting payments. Initiates, conducts, and concludes scheduled auctions for content. The auction service will support several auction models and will conduct auctions according to the rules of the model specified by the seller of the content.

Streaming Service 440. A wrapping service around the repository of content that has been transcoded from the original submitted format into the common format for use within the system. The streaming service will be able to locate a requested transcoded piece of content, retrieve that content and package it to be viewed by the entity which requested the content. Note that transcoded videos may potentially be stored locally or distributed within a content delivery service.

Security Service (not shown). Every other system in the system will interact with the security service, which is responsible for answering the question “can this person perform this action on this thing”. The security service is responsible for authentication, authorization, and access control. It wraps around all of the other services and resides between the services and the user attempting to use the service.

Those with skill in the arts will recognize that the system architecture could be implemented in many different ways and this disclosure is intended to include all such alternative configurations.

By catering directly to the needs and benefits of owners and creators of potentially valuable content, the invention captures the competitive advantage needed to convince creators to upload their content.

With the increasing omnipresence and integration of camera technology and broadband Internet with the daily lives of average consumers, the influx of valuable, independent media is expected to increase dramatically, further justifying the strong need for this invention.

Although described throughout as pertaining to content, images, and/or video, those with skill in the arts will recognize that the disclosed subject matter will also be used for other forms of intellectual property and this disclosure is intended to include all such variations. Additionally, those with skill in the arts will recognize that the disclosed embodiments have relevance to a wide variety of areas in addition to those specific examples described herein.

All references, including publications, patent applications, and patents, cited herein are hereby incorporated by reference to the same extent as if each reference were individually and specifically indicated to be incorporated by reference and were set forth in its entirety herein.

What is claimed is:

1. A method for an online content marketplace and exchange, the method comprising:
accepting auction preferences from an auctioning user, said auction preferences comprising auction settings and content information;
receiving content from said auctioning user, wherein said content is:
an audio recording;
an image; or
a video;
storing said content;
starting an auction, said auction according to said auction settings;
receiving bids from at least one bidder;
evaluating said bids to determine a winning bidder;
accepting funds from said winning bidder;
deducting a fee from said funds;
transferring the remainder of said funds to said auctioning user;
releasing said stored content to said winning bidder.

2. The method of claim 1, with the additional steps of:
copying said stored content;
transcoding said copied content;
watermarking said transcoded content; and
displaying said watermarked content.

3. The method of claim 2, with the additional step of transcoding said stored content into a format of said winning bidder's choosing and releasing to said winning bidder.

4. The method of claim 2, said auction settings being:
a type of listing, said type of listing being:
a private auction;
a public auction; or
a tiered auction;
a minimum bid amount;
an auction start time; and
an auction duration.

5. The method of claim 4, said auction settings also including an end auction amount.

6. The method of claim 2, said auction settings being:
a purchase amount; and
a store listing.

7. The method of claim 2, said content information being:
a title of said content;
a description of said content;
at least one tag, said tag describing said content;
a date said content was acquired or developed; and
a genre describing said content, said genre being at lest one of:
news;
entertainment;
sports;
creative; and
public figures.

8. The method of claim 7, said content information additionally including:
a time said content was acquired or developed;
a geographic location which said content regards or where said content was acquired or developed.

9. The method of claim 1, said step of starting an auction is completed in response to receiving said bid.

10. The method of claim 1, with the addition of one of the following steps:
copying said stored content, transcoding said copied content, and displaying said transcoded content; or
copying said stored content, watermarking said stored content, and displaying said watermarked content.

11. A computer readable medium, said medium encoded with a program, said program capable of executing the following steps:
accepting auction preferences from an auctioning user, said auction preferences comprising auction settings and content information;
receiving content from said auctioning user, wherein said content is:
an audio recording;
an image; or
a video;
storing said content;
starting an auction, according to said auction settings;
receiving bids from at least one bidder;
evaluating said bids to determine a winning bidder;
accepting funds from said winning bidder;
deducting a fee from said funds;
transferring the remainder of said funds to said auctioning user;
releasing said stored content to said winning bidder.

12. The medium of claim 11, said step of starting an auction is completed in response to receiving said bid.

13. The medium of claim 11, with the addition of one of the following steps:
copying said stored content, transcoding said copied content, and displaying said transcoded content;
copying said stored content, watermarking said copied content and displaying said watermarked content; or
copying said stored content, transcoding said copied content, watermarking said transcoded content, and displaying said watermarked content.

14. The medium of claim 11, said auction settings being:
a type of listing, said type of listing being:
a private auction;
a public auction; or
a tiered auction;
a minimum bid amount;
an auction start time; and
an auction duration.

15. The method of claim 11, said content information being:
a title of said content;
a description of said content;
at least one tag, said tag describing said content;
a date said content was acquired or developed; and
a genre describing said content, said genre being at lest one of:
news;
entertainment;
sports;
creative; and
public figures.

16. A system for an online content marketplace and exchange, the system comprising:
a communications interface configured to receive content, content information, and auction settings from an auctioning user, said content being an audio recording, an image, or a video;
a storage service storing said content on a computer readable medium;
an auction service accepting bids from one or more bidding users, and determining a winning bidder based on said bids and said auction settings;
a funds settlement service accepting funds from said winning bidder, deducting a fee from said funds, and transferring the remainder of said funds to said auctioning user;
a purchase distribution service retrieving said content from said computer readable medium and distributing said content to said winning bidder.

17. The system of claim 16, with the addition of said storage service also copying said stored content and at least one of the following:
a transcoding service transcoding said copied content; and
a watermarking service watermarking said copied content.

18. The system of claim 16, said content information being:
a title of said content;
a description of said content;
a genre of said content, wherein said genre is one or more of the following:
news;
entertainment;
sports;
creative; and
public figures;
at least one tag describing said content; and
a date said content was acquired or developed.

19. The system of claim 18, said content information also including a geographic location which said content regards or where said content was acquired or developed.

20. The system of claim 16, said auction settings being:
a type of listing, wherein said type of listing is:
a private auction;
a public auction; or
a tiered auction;
a minimum bid amount;
an auction start time; and
an auction duration.
